(19) United States
(12) Patent Application Publication
(10) Pub. No.: US 2022/0145531 A1
(43) Pub. Date: May 12, 2022

(54) METHOD FOR TEXTILE PRINTING

(71) Applicant: HEWLETT-PACKARD DEVELOPMENT COMPANY, L.P., Spring, TX (US)

(72) Inventors: Dennis Z. GUO, San Diego, CA (US); Jie ZHENG, San Diego, CA (US); Or BRANDSTEIN, San Diego, CA (US)

(73) Assignee: HEWLETT-PACKARD DEVELOPMENT COMPANY, L.P., Spring, TX (US)

(21) Appl. No.: 17/435,265

(22) PCT Filed: Jul. 30, 2019
(86) PCT No.: PCT/US2019/044171

§ 371 Date: Aug. 31, 2021

(51) Int. Cl. D06P 5/30; B41M 5/00; B41M 7/00; D06P 5/20; D06P 5/00; D06P 1/673; D06P 1/52; C09D 11/322; C09D 11/54; C09D 11/037; C09D 11/102

(52) U.S. Cl. CPC D06P 5/30; B41M 5/0047; B41M 5/0017; B41M 7/009; D06P 5/2016; D06P 5/2072; C09D 11/102; D06P 5/002; D06P 1/673; D06P 1/5285; C09D 11/322; C09D 11/54; C09D 11/037; D06P 5/2077

(57) ABSTRACT

A method is presented for direct digital printing on a textile substrate utilizing a two-step pretreatment comprising a plasma pretreatment and a heat pretreatment step followed by inkjet printing on the textile and a final heat treatment step.

### BACKGROUND

Inkjet printing technology offers many benefits over older analog printing technologies and because of this it is expanding in applications from printing on paper. Recent developments have been investigating additional applications of inkjet printing to different substrates such as textiles. Analog textile printing is usually accomplished by rotary or screen printing. These traditional techniques usually involve the creation of an actual physical screen or plate that is used to apply the image to the textile. Digital methods such as inkjet offer more flexibility and shorter runs since there is no physical screen or plate required but rather print creation directly from an electronic image. Inkjet printing is a non-impact printing method that utilizes electronic signals to control and direct ink droplets to the surface of a print substrate.

### BRIEF DESCRIPTION OF THE DRAWINGS

Features of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a diagram illustrating an example of a printing method disclosed herein;

FIG. 2A is a schematic top-down illustration of an example surface barrier discharge plasma generator in accordance with the present disclosure;

FIG. 2B is a schematic cross sectional illustration of an example surface barrier discharge plasma generator in accordance with the present disclosure;

FIG. 3 is a diagram illustrating an example of a printing system disclosed herein; and

FIG. 4 shows an example of a white printed area on a dark textile.

### DETAILED DESCRIPTION

Digital printing techniques such as inkjet printing provide a much more flexible and efficient means of printing versus older analog techniques especially in the area of industrial printing. In addition this flexibility and economic advantage of short runs and little to no set-up necessary has inspired the development of digital inkjet printing techniques that work on a wider array of substrates including textiles.

Analog textile printing is usually done with screens or rotary systems, both of which require a physical screen or plate to be made thereby limiting the ability to do short runs economically and limiting flexibility of the content. Digital systems such as inkjet work precisely because the image being applied to the substrate is generated wholly electronically and passed to the printheads to be directly applied to the substrate in real time allowing constantly changing content with little to no set-up required.

One difficulty with direct to garment digital printing of aqueous inkjet inks on textile substrates is the fact that many substrates are too hydrophilic and quickly absorb the applied ink. This is especially problematic for printing on dark textiles. In inkjet printing on a dark textile it is often preferable to initially print a white ink to provide a contrasting base layer on which the other color inks can be applied. It is necessary to maintain the applied ink at the surface of the textile in order to provide a higher degree of whiteness of the applied ink.

In addition to hydrophilicity of the substrate, many textile substrates such as cotton also have the phenomenon of fibrillation; small fibers that stick up out of the textile and disrupt the ink film applied leading to poor image quality.

In some applications a pretreatment fluid must be applied to the substrate surface to make the textile more amenable to printing as well as ameliorate the fibrillation effect, but this requires significant amounts of additional fluids to be applied which must then be removed. The method disclosed herein not only provides good print quality but also overcomes some of the inherent issues of a hydrophilic fibrillated textile substrate.

Described herein is a method for printing of a textile comprising providing a textile substrate, applying a plasma pretreatment, applying a first heat treatment to the textile substrate, applying a fixative agent, applying an inkjet ink and applying a second heat treatment to the pretreated, printed textile substrate.

Further described herein is a method for printing of a textile comprising providing a textile substrate, applying a plasma pretreatment using an ambient air plasma system, applying a first heat treatment to the textile substrate, applying an ink fixative agent, applying an inkjet ink, and finally applying a second heat treatment.

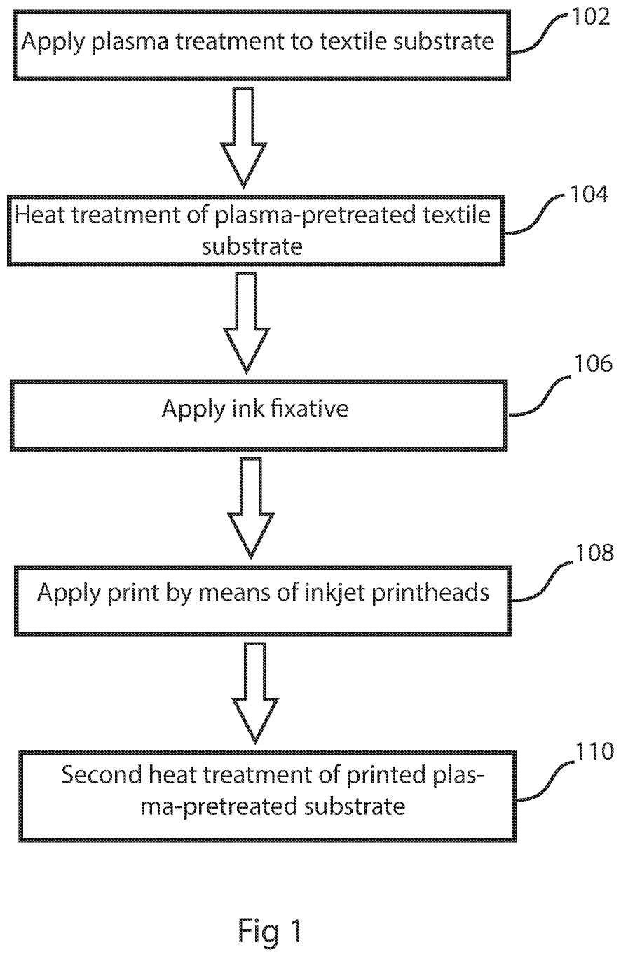

Referring now to FIG. 1 disclosed herein is a method of digital printing on a textile substrate comprising: providing a textile substrate, applying a plasma pretreatment using an ambient air plasma system (102) followed by applying a first heat treatment to the textile substrate (104) prior to applying an ink fixative agent (106) and applying an inkjet ink (108) and finally a second heat treatment (110).

In one example a suitable textile substrate for the present invention is selected from the group consisting of cotton, cotton blends, polyester, polyester blends, nylon, nylon blends, silk, silk blends and combinations thereof. In a further example the textile fabric is cotton. In a further example the textile substrate is a dark color. In yet another example the textile substrate is black.

The plasma pretreatment system used in the present method and system can be selected from the group consisting of low pressure plasma and atmospheric pressure plasma. Further, the plasma pretreatment system used in the present method can be an ambient air plasma system. Further, the plasma pretreatment system used in the present method can be a diffuse coplanar surface barrier discharge ambient air plasma system.

The first heat treatment of the herein described method can be applied at a temperature of 80° C. to 180° C. for a time of 15 sec to 5 min.

The ink fixative agent used in the current method comprises a cationic fixing agent and water.

Further the ink fixative agent comprises: an organic cosolvent, a cationic fixing agent and water.

The ink fixative formulation and the inkjet ink formulations of the present method and system can be applied digitally by means of an inkjet printhead. Inkjet printheads can include thermal, piezo, or continuous inkjet architecture. A thermal inkjet printhead can include a resistor that is heated by electric current. Inkjet ink can enter a firing chamber and the resistor can heat the ink sufficiently to form a bubble in the ink. The expansion of the bubble can cause a drop of ink to be ejected from a nozzle connected to the firing chamber. Piezo inkjet print heads are similar, except that instead of a thermal resistor, a piezoelectric element is used to mechanically force a drop of ink out of a nozzle. In a continuous inkjet printing system, a continuous stream of ink droplets is formed and some of the droplets can be selectively deflected by an electrostatic field onto the media substrate. The remaining droplets may be recirculated through the system. Inkjet print heads can be configured to print varying drop sizes such as less than 10 picoliters, less than 20 picoliters, less than 30 picoliters, less than 40 picoliters, less than 50 picoliters, etc

A suitable inkjet ink that may be used in the present disclosure can be an aqueous pigmented inkjet ink. Any aqueous pigmented inkjet ink may be used. The inkjet formulation may include a pigment dispersion, a polymeric binder, a liquid vehicle as well as additional functional additives.

In an example of the current method the inkjet ink of the current method is a white ink comprising a dispersion of a white pigment. In a further example the white pigment is selected from a group consisting of titanium dioxide, zinc oxide, zirconium oxide, calcium carbonate, alumina, aluminum oxyhydroxide, kaolinite and combinations thereof.

The inkjet ink applied in the current method can be applied to the substrate by means of an inkjet printhead.

The second heat treatment of the presently described method can be applied at temperatures of 100° C. to 180° C. for a time of 30 sec to 20 min.

Plasma Pretreatment System

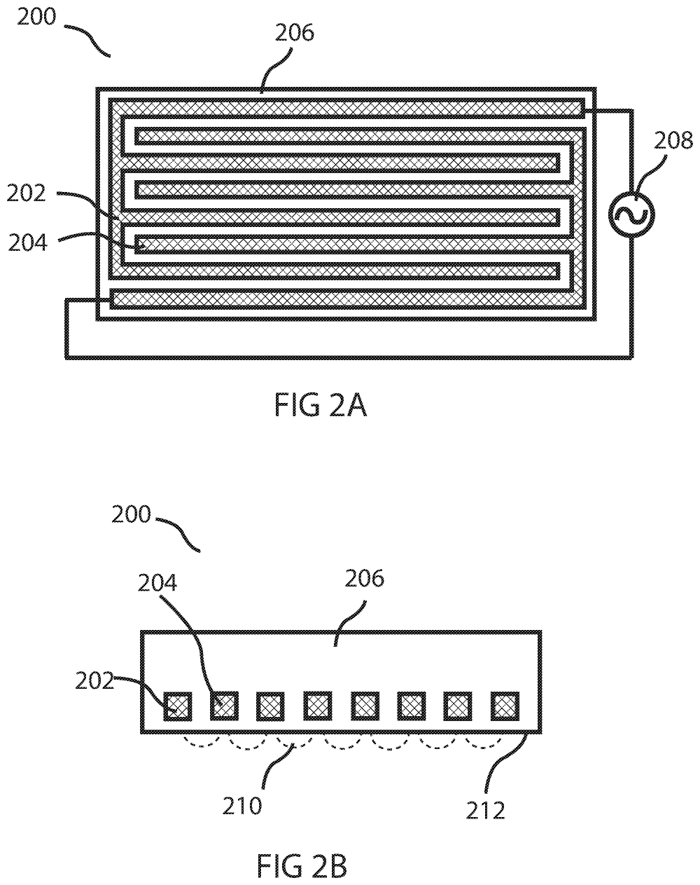

An exemplar plasma pretreatment system useful in the pretreatment of the textile substrate can be selected from the group consisting of low pressure plasma and atmospheric pressure plasma. In one example the plasma pretreatment system can be a surface barrier discharge plasma generator. This particular type of plasma generator is a type of dielectric barrier discharge plasma generator, and includes electrodes located beneath a surface of a dielectric material. The electrodes can be separated from each other and from the media substrate by the dielectric material. A high voltage alternating current can be applied across the electrodes to form diffuse plasma arcs on the surface of the dielectric material. FIGS. 2A and 2B show two projections of an example schematic of a surface barrier discharge plasma generator (200) having a first electrode (202) and a second electrode (204) embedded in a dielectric plate (206) in accordance with the present invention. FIG. 2A shows a cross-sectional plan view of the surface barrier discharge plasma generator. A power supply (208) applies a potential difference across the first electrode and the second electrode. FIG. 2B shows a cross-sectional elevation view of the surface barrier discharge plasma generator illustrating the plasma arcs (210) forming along the surface (212) of the dielectric plate.

The surface barrier discharge plasma generator can be a coplanar surface barrier discharge plasma generator. For example, the electrodes can be oriented in a common plane beneath the surface of the dielectric material. The surface of the dielectric material can be a flat planar surface. In another example the dielectric material can have a curved or other shape, and the electrodes can be oriented beneath the surface to conform to the shape of the surface. As a further example the electrodes can be located at an approximately uniform distance beneath the surface, regardless of the shape of the surface.

In some examples, the power supply for the plasma generating system can provide a high voltage alternating current. In certain examples, the surface barrier discharge plasma generator can be operated at a voltage from 1 kV to 30 kV. In further examples, the high voltage alternating current can have a frequency from 1 kHz to 500 kHz. In another example the plasma pretreatment system can be a diffuse coplanar surface barrier discharge ambient air plasma system such as the Roplass RPS40, RPS400, or RPS25x plasma system (Roplas s.r.o. Czech Republic).

As illustrated in FIG. 2B the first electrode (202) and the second electrode (204) can be oriented in a common plane embedded in the dielectric plate (206). The plasma arcs (210) can be confined to a volume close to the surface (212) of the common surface or the surface of the dielectric plate. For this reason the plasma arcs in this example can be referred to as “surface dielectric barrier discharge” which can be generated by a “surface barrier discharge plasma generator” as described herein. This is in contrast to a plasma generator that generates a volumetric dielectric barrier discharge wherein the barrier dielectric discharge occurs in a volumetric space between two electrodes rather than from a common surface. In volumetric dielectric barrier discharge plasma systems the electrodes may be oriented in parallel planes, such as two parallel plate electrodes with a dielectric barrier disposed in the space between the electrodes from two different surfaces. Thus, the plasma arcs form in the volume between the electrodes. In a surface barrier discharge plasma generator system (200) such as illustrated in FIGS. 2A and 2B the plasma tends to be more homogenous with a higher energy density than volumetric dielectric barrier discharge plasma systems.

In some examples, the plasma generated by the surface barrier discharge plasma generator can have a depth of 0.1 mm to 5 mm, meaning that the plasma thus generated extends 0.1 mm to 5 mm from the surface of the dielectric plate (206). In further examples the plasma generated by the surface barrier discharge plasma generator can have a depth of 0.2 mm to 2 mm or from 0.5 mm to 1 mm. The plasma can have a high energy density of from 50 W/cm³ to 250 W/cm³. In further examples, the plasma can have an energy density from 75 W/cm³ to 200 W/cm³ or from 80 W/cm³ to 150 W/cm³. In terms of surface area of the substrate being thus plasma treated, the areal energy density of the plasma can be from 0.5 W/cm² to 250 W/cm², from 1 W/cm² to 50 W/cm², or from 2 W/cm² to 10 W/cm², as different examples.

The plasma generated by the surface barrier discharge plasma generator can be a “cold” plasma. An example of a “cold” plasma is one in which the plasma has a temperature of less than 50° C., thus enabling the plasma to be used on a variety of substrates such as paper without damaging the substrates due to high temperature.

In further examples, the surface barrier discharge plasma generator can operate at atmospheric pressure in an atmosphere of normal air. Unlike some other types of plasma generators, surface barrier discharge plasma generators in some cases do not require reduced pressure or any special gas flow to operate. For example, some other types of plasma generators employ high gas flows to blow a plasma arc out of a nozzle. The gas required for these systems in some cases includes noble gases such as Argon or Helium. In contrast, the surface barrier discharge plasma generators described herein can be used under normal atmospheric conditions.

In some examples, the surface barrier discharge plasma generator can modify the surface of the substrate being treated so that the surface has improved interactions with inkjet inks. Without being bound to a particular mechanism, the plasma pretreatment can produce a variety of oxidizing species such as atomic oxygen and OH radicals. These species can react with surface functional groups on the substrate being treated to form oxygen containing groups such as —OH and carbonyl (—C═O) groups. In other examples the plasma pretreatment can modify the surface of the media substrate without significantly altering the pH of the surface, in other words without significant formation of acid groups on the surface.

In other examples the surface barrier discharge plasma generator can create cationic species on the surface of the treated substrate, depending on the substrate being treated.

In an example the surface barrier discharge plasma generator can modify the surface energy and the relative hydrophobicity or hydrophilicity of the substrate thus pretreated by the surface barrier discharge plasma generator. In other examples the surface barrier discharge plasma generator can also aid in the development of a more hydrophobic surface on certain substrates. Hydrophobic surfaces of print substrates are characterized by a low surface energy which tends to increase the contact angle of an applied fluid. When a fluid is applied to a substrate it can wet the substrate to varying degrees as a function of the surface tension of the fluid as well as the surface energy of the substrate upon which the fluid is applied following the Young-LaPlace Equation. The Young-Laplace equation relates the contact angle of a droplet of applied fluid resting on a surface as a function of the surface tension of the fluid and the surface energy of the substrate. On a more “hydrophobic” surface a droplet of water will wet the surface less and maintain a higher contact angle. If a droplet of water is applied to a more “hydrophilic” surface it will spread and wet the surface resulting in a lower contact angle. In some example applications of a surface barrier discharge plasma generator a surface can be made more hydrophobic, thus reducing an applied fluid's overall wetting of the substrate.

Substrate

In the present disclosure the printing method presented can be applied to a variety of substrates including but not limited to textiles, non-woven materials or synthetic materials. In an example the print method of the present disclosure can be conducted with a textile substrate selected from a group consisting of cotton fabrics, cotton blend fabrics, nylon fabrics, nylon blend fabrics, silk fabrics, silk blend fabrics, polyester fabrics, polyester blend fabrics, and combinations thereof. In a further example the textile substrate can be an organic and/or inorganic textile fabric. In yet another example the polyester fabric can be a polyester coated fabric.

It is to be understood that in the present disclosure the textile substrate can be a natural fiber fabric that can be treated or untreated natural fiber textile; e.g., wool, cotton, silk, linen, jute, flax, hemp, rayon fibers, or thermoplastic aliphatic polymeric fibers such as those derived from cornstarch, tapioca, or sugarcane, etc.

It is also to be understood that in the present disclosure the textile substrate can alternately be a synthetic fiber fabric such as but not limited to nylon, polyvinyl chloride (PVC), PVC-free polyester fibers, polyamide, polyimide, polyacrylic, polypropylene, polyethylene, polyurethane, polystyrene, polyaramid, polytetrafluorethylene (Teflon®, a trademark of E.I. du Pont de Nemours and Co. Delaware, USA), fiberglass, polytrimethylene, polycarbonate, polyethylene terephthalate, polyester terephthalate, polybutylene terephthalate, and combinations thereof.

The textile substrate can be of any color. In one example of the present disclosure the textile substrate is a dark colored fabric which may require the application of a white ink to provide contrast for subsequent inks applied.

In further examples the fibers and fabrics listed above can be modified. The term “modified fiber” refers to one or both of the fiber and the fabric having undergone a chemical or physical process such as, but not limited to, copolymerization with monomers of other polymers, chemical grafting reactions, plasma pretreatment, solvent treatment, etching, biological treatment, enzyme treatment, or antimicrobial treatment.

The substrate presented to the print method of the present disclosure has a specific surface chemistry and associated surface energy based on the chemical nature or treatment of the substrate. This surface energy can impart a hydrophobicity or hydrophilicity to the fabric as provided, meaning it will resist wetting with an aqueous solution or readily absorb the aqueous solution respectively. One of the potential benefits of the method presented in the present disclosure is to allow for the modification of the relative hydrophobicity or hydrophilicity of the substrate prior to printing so as to ensure that the print thus applied to the substrate will have a good print quality as well as durability.

Heating Systems

The method and system outlined in the present disclosure can comprise, among other steps, two heating steps; the first heating step subsequent to the plasma pretreatment and the second heating step subsequent to the printing step. Heating can be done using any known means in the art. Heating for printing of textiles is commonly achieved by means of a clamshell hot press, an oven or a conveyor dryer. A non-limiting example may include an open clamshell hot press such as 16″×20″ Hotronix Auto open clamshell hot press (Stahl's Hotronix, USA). In another example the heating system can be a forced air dryer or a radiative infrared dryer or a combination thereof. In yet another example the heaters may be conductive or radiative heaters. In yet another example the heating system can be selected from a group consisting of conveyor dryers, drawer drying cabinets, flash driers, tensionless dryers or combinations thereof.

Heating may also be accomplished by exposure to electromagnetic radiation. The source of electromagnetic radiation may be infrared (IR) or near-infrared (NIR, near-IR) light sources, such as IR or near-IR curing lamps, lasers with the desirable IR or near-IR electromagnetic wavelengths, or any combination thereof. Additionally the substrate may be heated by exposure to different wavelengths of light including but not limited to UV and may include a non-radiative energy transfer after photon absorption by the substrate providing additional heating.

In an additional example the heater in either the first or second heating step can be stationary or scanned across the print substrate. In addition the heaters may be place above or below the substrate.

Ink Fixative Agent

The ink fixative agent applied after the pretreatment and heating steps (106) can be applied either by analog or digital means. In one example the fixative solution is applied by the use of an inkjet printhead.

An example of the ink fixative solution comprises: a cationic fixing agent, an organic cosolvent, a surfactant and water.

The cationic fixing agent of the fixative solution can include an azetidinium-containing polyamine. The cationic fixing agent selected for use can be any of a number of cationic polyamines with a plurality of azetidinium groups. In some examples, the cationic fixing agent including the azetidinium-containing polyamine can be derived from the reaction of a polyalkylene polyamine (e.g. ethylenediamine, bishexamethylenetriamine, and hexamethylenediamine, for example) with an epihalohydrin (e.g. epichlorohydrin, for example) (referred to as PAmE resins). The cationic fixing agent can include a quaternary amine (e.g. azetidinium group) and a non-quaternary amine (i.e. a primary amine, a secondary amine, a tertiary amine, or a combination thereof). In some specific examples, the cationic fixing agent can include a quaternary amine and a tertiary amine. In some additional examples, the cationic fixing agent can include a quaternary amine and a secondary amine. In some further examples, the cationic fixing agent can include a quaternary amine and a primary amine. It is noted that, in some examples, some of the azetidinium groups of the cationic fixing agent can be crosslinked to a second functional group along the azetidinium-containing polyamine. Examples of commercially available azetidinium-containing polyamines that may be useful in this application include but are not limited to Crepetrol™ 73, Kymene™ 736, Polycup™ 1884, Polycup™ 7360, and Polycup™ 7360A each available from Solenis LLC (Delaware, USA).

The cationic fixing agent can be present in the fixative formulation in a range between 0.3 wt % and 15 wt %. In another example the cationic fixing agent can be present in the fixative formulation between 1 wt % and 4.5 wt %.

The surfactant in the ink fixative formulation can be water soluble and may include alkyl polyethylene oxides, alkyl phenyl polyethylene oxides, polyethylene oxide (PEO) block copolymers, acetylenic PEO, PEO esters, PEO amines, PEO amides, dimethicone copolyols, ethoxylated surfactants, alcohol ethoxylated surfactants, fluorosurfactants, and mixtures thereof. In some examples, the surfactant can include a nonionic surfactant, such as a Surfynol® surfactant, e.g., Surfynol® 440 (Evonik, Germany), or a Tergitol™ surfactant, e.g., Tergitol™ TMN-6 (from Dow Chemical, USA). In another example, the surfactant can include an anionic surfactant, such as a phosphate ester of a C₁₀ to C20 alcohol or a polyethylene glycol (3) oleyl mono/di phosphate, e.g., Crodafos® N3A (from Croda International PLC, United Kingdom). The surfactant can be included in the ink fixative formulation in a range of 0.01 wt % to 5 wt % and, in some examples, can be present at from 0.05 wt % to 3 wt % of the ink compositions. In yet another example the surfactant can be present in a range of 0.1 wt % to 0.4 wt %

The cosolvent present in the ink fixative formulation can include polar solvents, such as alcohols, amides, esters, ketones, lactones, and ethers. In additional detail, solvents that can be used can include aliphatic alcohols, aromatic alcohols, diols, glycol ethers, polyglycol ethers, caprolactams, formamides, acetamides, and long chain alcohols. Examples of such compounds include primary aliphatic alcohols, secondary aliphatic alcohols, 1.2-alcohols, 1.3-alcohols, 1.5-alcohols, ethylene glycol alkyl ethers, propylene glycol alkyl ethers, e.g., Dowanol™ TPM (from Dow Chemical, USA), higher homologs (C₆-C₁₂) of polyethylene glycol alkyl ethers, N-alkyl caprolactams, unsubstituted caprolactams, both substituted and unsubstituted formamides, both substituted and unsubstituted acetamides, and the like. More specific examples of organic solvents can include 2-pyrrolidone, 2-ethyl-2-(hydroxymethyl)-1.3-propane diol (EPHD), glycerol, dimethyl sulfoxide, sulfolane, glycol ethers, alkyldiols such as 1.2-hexanediol, and/or ethoxylated glycerols such as LEG-1, etc.

In an example the cosolvent is 2-pyrrolidone present in the ink fixative formulation in a range of 3 wt % to 15 wt %. In another example the 2-pyrrolidone cosolvent is present in a range of 10 wt % to 13 wt %.

The ink fixative agent used in the current method can comprise 5 wt % to 15 wt % organic cosolvent, 0.1 wt % to 5 wt % cationic fixing agent, 0.01 wt % to 5 wt % surfactant and the balance being water.

Inkjet Ink

The inkjet ink applied in the method (108) can be applied either by analog or digital means. In one example the inkjet ink is applied by the use of an inkjet printhead.

An example of the inkjet ink comprises: water, a pigment colorant, a cosolvent, a humectant, a surfactant, a polymeric binder, as well as functional additives such as surfactants and biocides.

Pigments

The pigment dispersion may include a pigment with added dispersant or a self-dispersing pigment. The pigment may be of any color, black or white. As specific examples the pigment may be any color, including but not limited to, a white pigment, a black pigment, a cyan pigment, a magenta pigment, a yellow pigment, a violet pigment, a green pigment, a red pigment, a blue pigment, an orange pigment or combinations thereof.

Examples of suitable white pigments include a white metal oxide pigment which imparts a white color to the ink. These pigments may themselves be white or may be essentially colorless but have a sufficiently high index of refraction such that they impart a white color to the final ink formulation. Examples of suitable white pigments include titanium dioxide particles, zinc oxide particles, zirconium oxide particles, calcium carbonate, alumina, aluminum oxyhydroxide, kaolinite or combinations thereof, or the like. In one specific example, the white metal oxide pigment can be titanium dioxide (TiO₂), and even more specifically, rutile.

Pigments with high light scattering capabilities, such as these, can be selected to enhance light scattering and lower transmittance, thus increasing opacity. White metal oxide pigments can have a particle size from about 120 nm to 700 nm, or from 300 nm to about 600 nm, or more typically, from about 400 nm to 550 nm, and in still another example, from about 180 nm to 400 nm. The combination of these pigments within these size ranges, appropriately spaced from one another with ingredients such as the alumina coating, amphoteric alumina particles, and latex particles, high opacity can be achieved at relatively thin thickness, e.g., 20 gsm to 150 gsm or 30 gsm to 100 gsm after removal of water and other solvent(s) from the printed ink and fixer film. In some examples, the white pigment dispersed in the ink vehicle; is present in an amount representing from about 5 wt % to about 25 wt % of the total ink weight.

In some other examples, the white pigment dispersed in the ink vehicle has an alumina coating. The white metal oxide pigment can thus be an alumina-coated pigment.

Examples of alumina-coated pigment that can be used include Ti-Pure® R960, available from Chemours (USA), which has an alumina content of about 3.3 wt % and an amorphous silica content of about 5.5 wt % based on the pigment content, and thus, when milled with polymeric dispersant, can form the suspended flocs, which may be easily resuspended when formulated with the amphoteric alumina particles and monovalent salts. Other coated pigments that can be used include TR® 50 (2.6 wt % alumina coating), TR® 52 (3.4 wt % alumina coating),TR60 (3.1 wt % alumina coating), TR® 90 (4 wt % alumina coating), and TR® 93 (3.9 wt % alumina coating), each from Huntsman Chemical (USA); Ti-Pure® R900 (4.3 wt % alumina coating) and Ti-Pure® R931 (6.4 wt % alumina coating), each available from Chemours; and CR®-813 (3.5 wt % alumina coating) and CR®-828 (3.5 wt % alumina coating), each available from Chemours. Notably, these coating weight percentages are based on the pigment weight, and furthermore, silica may also be included with these coatings at various concentrations either greater than or less than the alumina content. In further detail regarding the alumina coating that can be applied to the white metal oxide pigment, any of a number of alumina compositions can be used. The alumina can be coated on the pigment by precipitation from a liquid phase, and in some examples, there are commercially available alumina-containing TiO₂ pigments (or other white metal oxide pigments) that can be used. These commercially available pigments which include alumina can be milled with polymeric dispersant, as described in greater detail hereinafter. Thus, the white metal oxide coating can include alumina, such as alumina or an admixture of alumina and silica, e.g., amorphous-silicate (aluminosilicate). In accordance with this, an ink of the present disclosure can include an aqueous ink vehicle, and from 5 wt % to 25 wt % of white metal oxide pigment having an alumina coating, e.g., an alumina-containing coating of alumina or of amorphous-silicate (aluminosilicate which is a combination of both alumina and silica), etc.

Examples of suitable blue or cyan organic pigments include C.I. Pigment Blue 1, C.I. Pigment Blue 2, C.I. Pigment Blue 3, C.I. Pigment Blue 15, Pigment Blue 15:3, C.I. Pigment Blue 15:4, C.I. Pigment Blue 16, C.I. Pigment Blue 18, C.I. Pigment Blue 22, C.I. Pigment Blue 25, C.I. Pigment Blue 60, C.I. Pigment Blue 65, C.I. Pigment Blue 66, C.I. Vat Blue 4, and C.I. Vat Blue 60.

Examples of suitable magenta, red, or violet organic pigments include C.I. Pigment Red 1, C.I. Pigment Red 2, C.I. Pigment Red 3, C.I. Pigment Red 4, C.I. Pigment Red 5, C.I. Pigment Red 6, C.I. Pigment Red 7, C.I. Pigment Red 8, C.I. Pigment Red 9, C.I. Pigment Red 10, C.I. Pigment Red 11, C.I. Pigment Red 12, C.I. Pigment Red 14, C.I. Pigment Red 15, C.I. Pigment Red 16, C.I. Pigment Red 17, C.I. Pigment Red 18, C.I. Pigment Red 19, C.I. Pigment Red 21, C.I. Pigment Red 22, C.I. Pigment Red 23, C.I. Pigment Red 30, C.I. Pigment Red 31, C.I. Pigment Red 32, C.I. Pigment Red 37, C.I. Pigment Red 38, C.I. Pigment Red 40, C.I. Pigment Red 41, C.I. Pigment Red 42, C.I. Pigment Red 48(Ca), C.I. Pigment Red 48(Mn), C.I. Pigment Red 57(Ca), C.I. Pigment Red 57:1, C.I. Pigment Red 88, C.I. Pigment Red 112, C.I. Pigment Red 114, C.I. Pigment Red 122, C.I. Pigment Red 123, C.I. Pigment Red 144, C.I. Pigment Red 146, C.I. Pigment Red 149, C.I. Pigment Red 150, C.I. Pigment Red 166, C.I. Pigment Red 168, C.I. Pigment Red 170, C.I. Pigment Red 171, C.I. Pigment Red 175, C.I. Pigment Red 176, C.I. Pigment Red 177, C.I. Pigment Red 178, C.I. Pigment Red 179, C.I. Pigment Red 184, C.I. Pigment Red 185, C.I. Pigment Red 187, C.I. Pigment Red 202, C.I. Pigment Red 209, C.I. Pigment Red 219, C.I. Pigment Red 224, C.I. Pigment Red 245, C.I. Pigment Red 286, C.I. Pigment Violet 19, C.I. Pigment Violet 23, C.I. Pigment Violet 32, C.I. Pigment Violet 33, C.I. Pigment Violet 36, C.I. Pigment Violet 38, C.I. Pigment Violet 43, and C.I. Pigment Violet 50. Any quinacridone pigment or a co-crystal of quinacridone pigments may be used for magenta inks.

Examples of suitable yellow organic pigments include C.I. Pigment Yellow 1, C.I. Pigment Yellow 2, C.I. Pigment Yellow 3, C.I. Pigment Yellow 4, C.I. Pigment Yellow 5, C.I. Pigment Yellow 6, C.I. Pigment Yellow 7, C.I. Pigment Yellow 10, C.I. Pigment Yellow 11, C.I. Pigment Yellow 12, C.I. Pigment Yellow 13, C.I. Pigment Yellow 14, C.I. Pigment Yellow 16, C.I. Pigment Yellow 17, C.I. Pigment Yellow 24, C.I. Pigment Yellow 34, C.I. Pigment Yellow 35, C.I. Pigment Yellow 37, C.I. Pigment Yellow 53, C.I. Pigment Yellow 55, C.I. Pigment Yellow 65, C.I. Pigment Yellow 73, C.I. Pigment Yellow 74, C.I. Pigment Yellow 75, C.I. Pigment Yellow 77, C.I. Pigment Yellow 81, C.I. Pigment Yellow 83, C.I. Pigment Yellow 93, C.I. Pigment Yellow 94, C.I. Pigment Yellow 95, C.I. Pigment Yellow 97, C.I. Pigment Yellow 98, C.I. Pigment Yellow 99, C.I. Pigment Yellow 108, C.I. Pigment Yellow 109, C.I. Pigment Yellow 110, C.I. Pigment Yellow 113, C.I. Pigment Yellow 114, C.I. Pigment Yellow 117, C.I. Pigment Yellow 120, C.I. Pigment Yellow 122, C.I. Pigment Yellow 124, C.I. Pigment Yellow 128, C.I. Pigment Yellow 129, C.I. Pigment Yellow 133, C.I. Pigment Yellow 138, C.I. Pigment Yellow 139, C.I. Pigment Yellow 147, C.I. Pigment Yellow 151, C.I. Pigment Yellow 153, C.I. Pigment Yellow 154, C.I. Pigment Yellow 155, C.I. Pigment Yellow 167, C.I. Pigment Yellow 172, C.I. Pigment Yellow 180, C.I. Pigment Yellow 185, and C.I. Pigment Yellow 213.

Carbon black may be a suitable inorganic black pigment. Examples of carbon black pigments include those manufactured by Mitsubishi Chemical Corporation (Japan) such as, e.g., carbon black No. 2300, No. 900, MCF88, No. 33, No. 40, No. 45, No. 52, MA7, MA8, MA100, and No. 2200B; various carbon black pigments of the RAVEN® series manufactured by Columbian Chemicals Company, (Marietta, Ga.), such as, e.g., RAVEN® 5750, RAVEN® 5250, RAVEN® 5000, RAVEN® 3500, RAVEN® 1255, and RAVEN® 700; various carbon black pigments of the REGAL® series, BLACK PEARLS® series, the MOGUL® series, or the MONARCH® series manufactured by Cabot Corporation (Massachusetts, USA), such as, e.g., REGAL® 400R, REGAL® 330R, REGAL® 660R, BLACK PEARLS® 700, BLACK PEARLS® 800, BLACK PEARLS® 880, BLACK PEARLS® 1100, BLACK PEARLS® 4350, BLACK PEARLS® 4750, MOGUL® E, MOGUL® L, and ELFTEX® 410; and various black pigments manufactured by Evonik Degussa Orion Corporation, (Parsippany, N.J.), such as, e.g., Color Black FW1, Color Black FW2, Color Black FW2V, Color Black FW18, Color Black FW200, Color Black S150, Color Black S160, Color Black S170, PRINTEX® 35, PRINTEX® 75, PRINTEX® 80, PRINTEX® 85, PRINTEX® 90, PRINTEX® U, PRINTEX® V, PRINTEX® 140U, Special Black 5, Special Black 4A, and Special Black 4. An example of an organic black pigment includes aniline black, such as C.I. Pigment Black 1.

Some examples of green organic pigments include C.I. Pigment Green 1, C.I. Pigment Green 2, C.I. Pigment Green 4, C.I. Pigment Green 7, C.I. Pigment Green 8, C.I. Pigment Green 10, C.I. Pigment Green 36, and C.I. Pigment Green 45. Examples of brown organic pigments include C.I. Pigment Brown 1, C.I. Pigment Brown 5, C.I. Pigment Brown 22, C.I. Pigment Brown 23, C.I. Pigment Brown 25, C.I. Pigment Brown 41, and C.I. Pigment Brown 42.

Some examples of orange organic pigments include C.I. Pigment Orange 1, C.I. Pigment Orange 2, C.I. Pigment Orange 5, C.I. Pigment Orange 7, C.I. Pigment Orange 13, C.I. Pigment Orange 15, C.I. Pigment Orange 16, C.I. Pigment Orange 17, C.I. Pigment Orange 19, C.I. Pigment Orange 24, C.I. Pigment Orange 34, C.I. Pigment Orange 36, C.I. Pigment Orange 38, C.I. Pigment Orange 40, C.I. Pigment Orange 43, C.I. Pigment Orange 64, C.I. Pigment Orange 66, C.I. Pigment Orange 71, and C.I. Pigment Orange 73.

The average particle size of the color pigments may range anywhere from about 20 nm to about 200 nm. In an example, the average particle size ranges from about 80 nm to about 150 nm.

Any of the pigments mentioned herein can be dispersed by a separate dispersant, such as a styrene (meth)acrylate dispersant, or another dispersant suitable for keeping the pigment suspended in the liquid vehicle. For example, the dispersant can be any dispersing (meth)acrylate polymer, or other type of polymer, such as maleic polymer or a dispersant with aromatic groups and a poly(ethylene oxide) chain.

In one example a white pigment such as TiO₂ can be dispersed using a polyacrylate polymer such as a partially neutralized low molecular weight water soluble acrylic acid polymer and example of which may be but is not limited to Carbosperse™ K-7028 (Lubrizol, USA). An example of a TiO₂ dispersion can be an aqueous mixture of TiO₂ at between 10 wt % and 60 wt % and a polyacrylate dispersant at between 0.1 wt % and 1 wt % of the mixture as well as a dispersant/surfactant that is a high molecular weight block copolymer such as Disperbyk@ 190 (Byk USA, USA) at between 0.1 wt % and 1 wt % of the mixture.

In an example, the white pigment is present in the inkjet ink in an amount ranging from about 3 wt % to about 15 wt % of the total weight of the inkjet ink. In another example, the pigment is present in the thermal inkjet ink in an amount ranging from about 6 wt % to about 12 wt % of the total weight of the inkjet ink. When the separate dispersant is used, the separate dispersant may be present in an amount ranging from about 0.05 wt % to about 2 wt % of the total weight of the inkjet ink. In some examples, the ratio of pigment to separate dispersant may range from 0.01 (0.1:10) to 0.2 (1:5).

For color pigments, (meth)acrylate polymer dispersant can be a styrene-acrylic type dispersant polymer, as it can promote π-stacking between the aromatic ring of the dispersant and various types of color pigments, such as copper phthalocyanine pigments, for example. Example commercially available styrene-acrylic dispersants can include JONCRYL® 671, JONCRYL® 71, JONCRYL® 96, JONCRYL® 680, JONCRYL® 683, JONCRYL® 678, JONCRYL® 690, JONCRYL® 296, JONCRYL® 696 or JONCRYL® ECO 675 (all available from BASF Corp., Germany)

The term “(meth)acrylate” or “(meth)acrylic acid” or the like refers to monomers, copolymerized monomers, etc., that can either be acrylate or methacrylate (or a combination of both), or acrylic acid or methacrylic acid (or a combination of both). Also, in some examples, the terms “(meth)acrylate” and “(meth)acrylic acid” can be used interchangeably, as acrylates and methacrylates are salts and esters of acrylic acid and methacrylic acid, respectively. Furthermore, mention of one compound over another can be a function of pH. Furthermore, even if the monomer used to form the polymer was in the form of a (meth)acrylic acid during preparation, pH modifications during preparation or subsequently when added to an ink composition can impact the nature of the moiety as well (acid form vs. salt or ester form). Thus, a monomer or a moiety of a polymer described as (meth)acrylic acid or as (meth)acrylate should not be read so rigidly as to not consider relative pH levels, ester chemistry, and other general organic chemistry concepts.

Self-Dispersed Color Pigments

In other examples, the inkjet color ink contains a self-dispersed pigment including a pigment and an organic group attached thereto.

Any of the pigments set forth herein may be used, such as carbon, phthalocyanine, quinacridone, azo, or any other type of organic pigment, as long as at least one organic group that is capable of dispersing the pigment is attached to the pigment.

The organic group that is attached to the pigment includes at least one aromatic group, an alkyl (e.g., C₁ to C₂₀), and an ionic or ionizable group.

The aromatic group may be an unsaturated cyclic hydrocarbon containing one or more rings and may be substituted or unsubstituted, for example with alkyl groups. Aromatic groups include aryl groups (for example, phenyl, naphthyl, anthracenyl, and the like) and heteroaryl groups (for example, imidazolyl, pyrazolyl, pyridinyl, thienyl, thiazolyl, furyl, triazinyl, indolyl, and the like).

The alkyl group may be branched or unbranched, substituted or unsubstituted.

The ionic or ionizable group may be at least one phosphorus-containing group, at least one sulfur-containing group, or at least one carboxylic acid group.

In an example, the at least one phosphorus-containing group has at least one P—O bond or P═O bond, such as at least one phosphonic acid group, at least one phosphinic acid group, at least one phosphinous acid group, at least one phosphite group, at least one phosphate, diphosphate, triphosphate, or pyrophosphate groups, partial esters thereof, or salts thereof. By “partial ester thereof”, it is meant that the phosphorus-containing group may be a partial phosphonic acid ester group having the formula —PO₃RH, or a salt thereof, wherein R is an aryl, alkaryl, aralkyl, or alkyl group. By “salts thereof”, it is meant that the phosphorus-containing group may be in a partially or fully ionized form having a cationic counterion.

In other examples, the ionic or ionizable group (of the organic group attached to the pigment) is a sulfur-containing group. The at least one sulfur-containing group has at least one S═O bond, such as a sulfinic acid group or a sulfonic acid group. Salts of sulfinic or sulfonic acids may also be used, such as —SO₃⁻X⁺, where X is a cation, such as Na⁺, H⁺, K⁺, NH₄⁺, Li⁺, Ca²⁺, Mg⁺, etc.

When the ionic or ionizable group is a carboxylic acid group, the group may be COOH or a salt thereof, such as —COO⁻X⁺, —(COO⁻X⁺)₂, or —(COO⁻X⁻)₃.

Examples of the self-dispersed pigments are commercially available as dispersions. Suitable commercially available self-dispersed pigment dispersions include those of the CAB-O-JET® 200 Series, manufactured by Cabot Corporation. Some specific examples include CAB-O-JET® 200 (black pigment), CAB-O-JET®250C (cyan pigment), CAB-O-JET® 260M or 265M (magenta pigment) and CAB-O-JET® 270 (yellow pigment)). Other suitable commercially available self-dispersed pigment dispersions include those of the CAB-O-JET® 400 Series, manufactured by Cabot Corporation. Some specific examples include CAB-O-JET® 400 (black pigment), CAB-O-JET® 450C (cyan pigment), CAB-O-JET® 465M (magenta pigment) and CAB-O-JET® 470Y (yellow pigment)). Still other suitable commercially available self-dispersed pigment dispersions include those of the CAB-O-JET® 300 Series, manufactured by Cabot Corporation. Some specific examples include CAB-O-JET®300 (black pigment) and CAB-O-JET® 352K (black pigment).

For the pigment dispersions disclosed herein, it is to be understood that the pigment and separate dispersant or the self-dispersed pigment (prior to being incorporated into the inkjet formulation), may be dispersed in water alone or in combination with an additional water soluble or water miscible cosolvent, such as 2-pyrrolidone, 1-(2-hydroxyethyl)-2-pyrrolidone, glycerol, 2-methyl-1,3-propanediol, 1,2-butane diol, diethylene glycol, triethylene glycol, tetraethylene glycol, or a combination thereof. It is to be understood however, that the liquid components of the pigment dispersion become part of the liquid vehicle in the ink formulation.

Binder

The binder in the inkjet ink can be a polymeric binder such as but not limited to a latex binder, a polyurethane binder or combinations thereof.

In an example, the inkjet ink includes the polyester-polyurethane binder. In an example, the polyester-polyurethane binder is a sulfonated polyester-polyurethane binder. The sulfonated polyester-polyurethane binder can include diaminesulfonate groups. In an example, the polyester-polyurethane binder is a sulfonated polyester-polyurethane binder, and is one of: i) an aliphatic compound including multiple saturated carbon chain portions ranging from C₄ to C₁₀ in length, and that is devoid of an aromatic moiety, or ii) an aromatic compound including an aromatic moiety and multiple saturated carbon chain portions ranging from C₄ to C₁₀ in length.

In one example, the sulfonated polyester-polyurethane binder can be anionic. In further detail, the sulfonated polyester-polyurethane binder can also be aliphatic, including saturated carbon chains as part of the polymer backbone or as a side-chain thereof, e.g., C₂ to C₁₀, C₃ to C₈, or C₃ to C₆ alkyl. These polyester-polyurethane binders can be described as “alkyl” or “aliphatic” because these carbon chains are saturated and because they are devoid of aromatic moieties. An example of an anionic aliphatic polyester-polyurethane binder that can be used is IMPRANIL® DLN-SD (CAS #375390-41-3; Mw 45,000 Mw; Acid Number 5.2; Tg −47° C.; Melting Point 175-200° C.) from Covestro (Germany). Example components used to prepare the IMPRANIL® DLN-SD or other similar anionic aliphatic polyester-polyurethane binders can include pentyl glycols (e.g., neopentyl glycol); C₄ to C₁₀ alkyldiol (e.g., hexane-1,6-diol); C₄ to C₁₀ alkyl dicarboxylic acids (e.g., adipic acid); C₄ to C₁₀ alkyl diisocyanates (e.g., hexamethylene diisocyanate (HDI)); diamine sulfonic acids (e.g., 1-[(2-aminoethyl)amino]-ethanesulfonic acid); etc.

Alternatively, the sulfonated polyester-polyurethane binder can be aromatic (or include an aromatic moiety) and can include aliphatic chains. An example of an aromatic polyester-polyurethane binder that can be used is DISPERCOLL® U42 (CAS #157352-07-3). Example components used to prepare the DISPERCOLL® U42 or other similar aromatic polyester-polyurethane binders can include aromatic dicarboxylic acids, e.g., phthalic acid; C₄ to C₁₀ alkyl dialcohols (e.g., hexane-1.6-diol); C₄ to C₁₀ alkyl diisocyanates (e.g., hexamethylene diisocyanate (HDI)); diamine sulfonic acids (e.g., 2-[(2-aminoethyl)amino]-ethanesulfonic acid); etc.

Other types of polyester-polyurethanes can also be used, including IMPRANIL® DL 1380, which can be somewhat more difficult to jet from thermal inkjet printheads compared to IMPRANIL® DLN-SD and DISPERCOLL® U42, but still can be acceptably jetted in some examples, and can also provide acceptable washfastness results on a variety of fabric types.

The polyester-polyurethane binders disclosed herein may have a weight average molecular weight (Mw) ranging from about 20,000 to about 300,000. As examples, the weight average molecular weight can range from about 50,000 to about 500,000, from about 100,000 to about 400,000, or from about 150,000 to about 300,000.

The polyester-polyurethane binders disclosed herein may have an acid number that ranges from about 1 mg/g KOH to about 50 mg/g KOH. For this binder, the term “acid number” refers to the mass of potassium hydroxide (KOH) in milligrams that is used to neutralize one gram of the sulfonated polyester-polyurethane binder. As examples, the acid number of the sulfonated polyester-polyurethane binder can range from about 1 mg KOH/g to about 200 mg KOH/g, from about 2 mg KOH/g to about 100 mg KOH/g, or from about 3 mg KOH/g to about 50 mg KOH/g.

In an example of the inkjet ink, the polyester-polyurethane binder has a weight average molecular weight ranging from about 20,000 to about 300,000 and an acid number ranging from about 1 mg KOH/g to about 50 mg KOH/g.

The average particle size of the polyester-polyurethane binders disclosed herein may range from about 20 nm to about 500 nm. As examples, the sulfonated polyester-polyurethane binder can have an average particle size ranging from about 20 nm to about 500 nm, from about 50 nm to about 350 nm, or from about 100 nm to about 250 nm.

The particle size of any solids herein, including the average particle size of the dispersed polymer binder, can be determined using a variety of particle sizing instrumentation known in the art. As examples NANOTRAC® Wave device, from Microtrac (Pennsylvania, USA), or the Zetasizer® device available from Malvern Pananlytical (UK) which measure particles size using dynamic light scattering. Other means including laser diffraction particle sizing such as that provided by the Mastersizer® 3000 system available from Malvern Pananlytical. Average particle size can be determined using particle size distribution data generated by the device.

Other examples of the ink include a polyether-polyurethane binder. Examples of polyether-polyurethanes that may be used include IMPRANIL® LP DSB 1069, IMPRANIL® DLE, IMPRANIL® DAH, or IMPRANIL® DL 1116 (Covestro (Germany)); or HYDRAN® WLS-201 or HYDRAN® WLS-201 K (DIC Corp. (Japan)); or TAKELAC® W-6061T or TAKELAC® WS-6021 (Mitsui (Japan)).

Still other examples of the ink include a polycarbonate-polyurethane binder. Examples of polycarbonate-polyurethanes that may be used as the polymeric binder include IMPRANIL® DLC-F or IMPRANIL® DL 2077 (Covestro (Germany)); or HYDRAN® WLS-213 (DIC Corp. (Japan)); or TAKELAC® W-6110 (Mitsui (Japan)).

In still other examples, the ink includes a latex polymer binder. The term “latex polymer” generally refers to any dispersed polymer prepared from acrylate and/or methacrylate monomers, including an aromatic (meth)acrylate monomer that results in aromatic (meth)acrylate moieties as part of the latex. In an example, the latex polymer may be devoid of styrene. In some examples, the latex particles can include a single heteropolymer that is homogenously copolymerized. In another example, a multi-phase latex polymer can be prepared that includes a first heteropolymer and a second heteropolymer. The two heteropolymers can be physically separated in the latex particles, such as in a core-shell configuration, a two-hemisphere configuration, smaller spheres of one phase distributed in a larger sphere of the other phase, interlocking strands of the two phases, and so on. If a two-phase polymer, the first heteropolymer phase can be polymerized from two or more aliphatic (meth)acrylate ester monomers or two or more aliphatic (meth)acrylamide monomers. The second heteropolymer phase can be polymerized from a cycloaliphatic monomer, such as a cycloaliphatic (meth)acrylate monomer or a cycloaliphatic (meth)acrylamide monomer. The first or second heteropolymer phase can include the aromatic (meth)acrylate monomer, e.g., phenyl, benzyl, naphthyl, etc. In one example, the aromatic (meth)acrylate monomer can be a phenoxylalkyl (meth)acrylate that forms a phenoxylalkyl (meth)acrylate moiety within the latex polymer, e.g. phenoxylether, phenoxylpropyl, etc. The second heteropolymer phase can have a higher T_{g} than the first heteropolymer phase in one example. The first heteropolymer composition may be considered a soft polymer composition and the second heteropolymers composition may be considered a hard polymer composition. If a two-phase heteropolymer, the first heteropolymer composition can be present in the latex polymer in an amount ranging from about 15 wt % to about 70 wt % of a total weight of the polymer particle, and the second heteropolymer composition can be present in an amount ranging from about 30 wt % to about 85 wt % of the total weight of the polymer particle. In other examples, the first heteropolymer composition can be present in an amount ranging from about 30 wt % to about 40 wt % of a total weight of the polymer particle, and the second heteropolymer composition can be present in an amount ranging from about 60 wt % to about 70 wt % of the total weight of the polymer particle.

In more general terms, whether there is a single heteropolymer phase, or there are multiple heteropolymer phases, heteropolymer(s) or copolymer(s) can include a number of various types of copolymerized monomers, including aliphatic(meth)acrylate ester monomers, such as linear or branched aliphatic (meth)acrylate monomers, cycloaliphatic (meth)acrylate ester monomers, or aromatic monomers. However, in accordance with the present disclosure, the aromatic monomer(s) selected for use can include an aromatic (meth)acrylate monomer. To be clear, reference to an “aromatic (meth)acrylate” does not include the copolymerization of two different monomers copolymerized together into a common polymer, e.g., styrene and methyl methacrylate. Rather, the term “aromatic (meth)acrylate” refers to a single aromatic monomer that is functionalized by an acrylate, methacrylate, acrylic acid, or methacrylic acid, etc.

The weight average molecular weight of the latex polymer can be from 50,000 Mw to 500,000 Mw, for example. The acid number of the latex polymer can be from 2 mg KOH/g to 40 mg KOH/g, from 2 mg KOH/g to 30 mg KOH/g, or 3 mg KOH/g to 26 mg KOH/g, or 4 mg KOH/g to 20 mg KOH/g, for example.

The latex polymer can be in acid form, such as in the form of a polymer with (meth)acrylic acid surface groups, or may be in its salt form, such as in the form of a polymer with poly(meth)acrylate groups.

In an example, any of the polyurethane-based polymeric binders may be present in the inkjet ink in a total amount ranging from about 2 wt % to about 15 wt % of the total weight of the inkjet ink. In another example, the latex polymer can be present in this example ink at a relatively high concentration, e.g., from 5 wt % to 20 wt %, from 6 wt % to 15 wt %, or from 7 wt % to 12 wt %, for example.

The polymeric binder (prior to being incorporated into the inkjet formulation) may be dispersed in water alone or in combination with an additional water soluble or water miscible cosolvent, such as those described for the pigment dispersion. It is to be understood however, that the liquid components of the binder dispersion become part of the liquid vehicle in the ink formulation.

Cosolvent

Cosolvent(s) can be present in the inkjet ink formulation and can include any cosolvent or combination of cosolvents that is compatible with the pigment, dispersant, polyurethane binder, etc. Examples of suitable classes of cosolvents include polar solvents, such as alcohols, amides, esters, ketones, lactones, and ethers. In additional detail, solvents that can be used can include aliphatic alcohols, aromatic alcohols, diols, glycol ethers, polyglycol ethers, caprolactams, formamides, acetamides, and long chain alcohols. Examples of such compounds include primary aliphatic alcohols, secondary aliphatic alcohols, 1.2-alcohols, 1.3-alcohols, 1.5-alcohols, ethylene glycol alkyl ethers, propylene glycol alkyl ethers, e.g., Dowanol™ TPM (from Dow Chemical, USA), higher homologs (C₆-C₁₂) of polyethylene glycol alkyl ethers, N-alkyl caprolactams, unsubstituted caprolactams, both substituted and unsubstituted formamides, both substituted and unsubstituted acetamides, and the like. More specific examples of organic solvents can include 2-pyrrolidone, 2-ethyl-2-(hydroxymethyl)-1.3-propane diol (EPHD), glycerol, dimethyl sulfoxide, sulfolane, glycol ethers, alkyldiols such as 1.2-hexanediol, and/or ethoxylated glycerols such as LEG-1, etc.

In an example the cosolvent content of the ink can include but is not limited to a mixture containing tripopylene glycol methyl ether at 0.5 wt % to 5 wt % of the ink formulation, ethoxylated glycerol at 0.5 wt % to 2 wt % of the ink formulation and glycerol at 1 wt % to 10 wt % of the ink formulation.

Additives

Other additives that can be present in the ink include biocides, surfactants and rheology control compounds. Biocides may include but are not limited to materials such as Acticide® B20 (Thor, USA), Proxel® (Lonza*, Switzerland) and combinations thereof. In one example the biocide is Acticide® B20 at 0.1 wt % to 0.5 wt % of the ink formulation.

Surfactant

The ink vehicle can also include surfactant. In general, the surfactant can be water soluble and may include alkyl polyethylene oxides, alkyl phenyl polyethylene oxides, polyethylene oxide (PEO) block copolymers, acetylenic PEO, PEO esters, PEO amines, PEO amides, dimethicone copolyols, ethoxylated surfactants, alcohol ethoxylated surfactants, fluorosurfactants, and mixtures thereof. In some examples, the surfactant can include a nonionic surfactant, such as a Surfynol® surfactant, e.g., Surfynol® 440 from Evonik (Germany), or a Tergitol™ surfactant, e.g., Tergitol™ TMN-6 from Dow Chemical (USA). In another example, the surfactant can include an anionic surfactant, such as a phosphate ester of a C₁₀ to C20 alcohol or a polyethylene glycol (3) oleyl mono/di phosphate, e.g., Crodafos® N3A from Croda International PLC (United Kingdom). The surfactant can be included in the inkjet ink formulation in a range of 0.01 wt % to 5 wt % and, in some examples, can be present at from 0.05 wt % to 3 wt % of the ink compositions. In yet another example the surfactant can be present in a range of 0.1 wt % to 0.4 wt %

In one embodiment of the present method the inkjet ink is a white ink comprising a dispersion of a white pigment, a binder, one or more cosolvents, a humectant, a surfactant, as well as optional additives such as a biocide and the balance being water.

Method

With the foregoing descriptions in mind, FIG. 1 illustrates the printing method described in the present disclosure. In this method a substrate is initially plasma treated (102) by the use of a plasma generating system and then passed through a first heat-treatment system (104). In one example the substrate is a textile substrate. In yet another example the substrate is a dark colored textile substrate.

After the substrate has been pretreated by the plasma generating system the textile substrate has ink fixative formulation jetted onto it by means an inkjet printhead (106). The textile substrate which has been plasma pretreated, heat treated and has an ink fixative formulation applied to it then moves under a series of inkjet printheads (108) each of which can be loaded with a variety of colors of ink or other fluids. The inkjet printheads respond to digital electronic signals which fire the inkjet printheads creating a printed image on the textile substrate. The inkjet printheads can be any type known in the art including thermal inkjet, piezo inkjet or continuous inkjet. In one example the first inkjet printhead can be loaded with white ink which is applied to dark textile substrates in order to either be its own color plane or provide a higher contrast base layer upon which subsequent color inks can be applied without loss of gamut or print quality. It is to be understood that the present invention is not limited solely to 4 colors and a white printhead, but rather that this is one possible embodiment of the method and system herein described.

After printing the textile substrate is then passed through a second heat treatment step (110) upon which it exits the printing system.

System

Further outlined in the present disclosure is a printing system comprising: a textile substrate, a means of pretreating the textile substrate by means of plasma pretreatment using a plasma system, a means of heating the plasma pretreated textile substrate after pretreatment, a means of application of a pretreatment solution, a means of printing of the textile substrate, a pigment-based ink, a means of providing a post-print drying of the plasma pretreated textile substrate which has been printed.

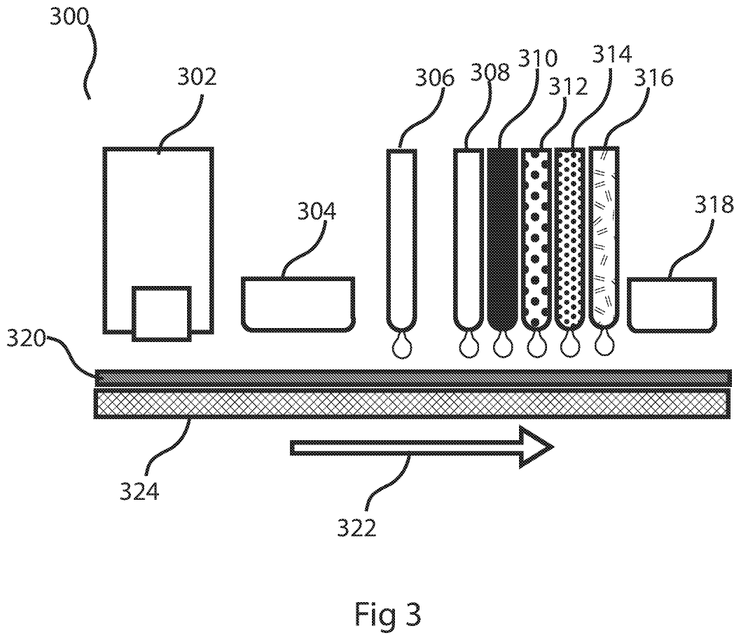

With the foregoing descriptions in mind, FIG. 3 illustrates an example of the print system (300) shown schematically. This example is to be understood as a non-limiting example with the primary goal being to show a possible implementation of the method and systems disclosed herein. In FIG. 3 the textile substrate (320) is moving in one direction (322) in relation to the various subsystems. The substrate is disposed on a platen (324) which can either be a static surface over which the various subsystems move or it can be a movable system which moves under the various other subsystems sequentially.

In the currently described printing system the means of pretreating the textile substrate is an ambient air plasma system. The plasma pretreatment system used in the present system can be selected from the group consisting of low pressure plasma and atmospheric pressure plasma. Further, the plasma pretreatment system used in the present method can be an ambient air plasma system. Further, the plasma pretreatment system used in the present method can be a diffuse coplanar surface barrier discharge ambient air plasma system.

The first heat treatment of the herein described system can be applied at a temperature of 80° C. to 180° C. for a time of 15 sec to 5 min.

The ink fixative formulation and the inkjet ink formulations of the present system can be applied digitally by means of an inkjet printhead. Inkjet printheads can include thermal, piezo, or continuous inkjet architecture. A thermal inkjet printhead can include a resistor that is heated by electric current. Inkjet ink can enter a firing chamber and the resistor can heat the ink sufficiently to form a bubble in the ink. The expansion of the bubble can cause a drop of ink to be ejected from a nozzle connected to the firing chamber. Piezo inkjet print heads are similar, except that instead of a thermal resistor, a piezoelectric element is used to mechanically force a drop of ink out of a nozzle. In a continuous inkjet printing system, a continuous stream of ink droplets is formed and some of the droplets can be selectively deflected by an electrostatic field onto the media substrate. The remaining droplets may be recirculated through the system. Inkjet print heads can be configured to print varying drop sizes such as less than 10 picoliters, less than 20 picoliters, less than 30 picoliters, less than 40 picoliters, less than 50 picoliters, etc

In an example of the current system the inkjet ink utilized by the current system is a white ink comprising a dispersion of a white pigment. In a further example the white pigment is selected from a group consisting of titanium dioxide, zinc oxide, zirconium oxide, calcium carbonate, alumina, aluminum oxyhydroxide, kaolinite and combinations thereof.

The inkjet ink applied in the current system can applied to the substrate by means of an inkjet printhead.

The second heat treatment of the presently described system can be applied at temperatures of 100° C. to 180° C. for a time of 30 sec to 20 min.

The substrate is initially plasma treated by the use of a plasma generating system (302) and then passed through a first heat-treatment system (304). After this the textile substrate has ink fixative formulation jetted onto it by means an inkjet printhead (306). The textile substrate which has been plasma pretreated, heat treated and has an ink fixative formulation applied to it then moves under a series of inkjet printheads (308, 310, 312, 314, 316) each of which can be loaded with a variety of colors of ink or other fluids. The inkjet printheads respond to digital electronic signals which fired the inkjet printheads creating a printed image on the textile substrate. The inkjet printheads can be any type known in the art including thermal inkjet, piezo inkjet or continuous inkjet. The first inkjet printhead (308) can be loaded with white ink which is applied to dark textile substrates in order to either be its own color plane or provide a higher contrast base layer upon which subsequent color inks can be applied without loss of gamut or print quality. It is to be understood that the present invention is not limited solely to 4 colors and a white printhead, but rather that this is one possible embodiment of the method and system herein described.

After printing the textile substrate is then passed through a second heat treatment step (318) upon which it exits the printing system.

In one example of the system the plasma generating system (302) can be a surface barrier discharge ambient air plasma system.

In yet another example of the system the first heating application can be provided by a heating system selected from a group consisting of an open clamshell hot press, a forced air dryer, a radiative infrared dryer, a conductive dryer, a conveyor dryer, a drawer drying cabinet, a flash dryer, a tensionless dryer or a combination thereof.

In another example the second heating application can be provided by a heating system selected from a group consisting of an open clamshell hot press, a forced air dryer, a radiative infrared dryer, a conductive dryer, a conveyor dryer, a drawer drying cabinet, a flash dryer, a tensionless dryer or a combination thereof.

In yet another example the inkjet printheads used for the application of the fixative formulation (306) and the ink (308, 310, 312, 314, 316) can be thermal inkjet printheads, piezo inkjet printheads or continuous inkjet printheads.

In yet another example the platen (324) is a static fixed surface upon which the substrate is placed and over which the plasma pretreatment (302), first heat-treatment system (304), ink fixative (306) and ink printheads (308, 310, 312, 314, 316) and second heat-treatment system (318) are moved.

In another example the platen (324) is a conveyor or moving surface upon which the substrate is placed and moved such that the substrate is moved sequentially under the plasma pretreatment (302), first heat-treatment system (304), ink fixative (306) and ink printheads (308, 310, 312, 314, 316) and second heat-treatment system (318)

### EXAMPLES

The following examples illustrate the technology of the present disclosure. It is to be understood that the following are only illustrative of the principles of the present disclosure. While the disclosure has been provided with particularity, the following describe further detail in connection with acceptable examples.

### Example 1. Preparation of Ink Fixative Formulation and Inkjet Ink

### Formulation

An example ink fixative formulation containing an azetidinium-containing polyamine was prepared according to the formulation that follows:

TABLE 1
Ink Fixative Formulation

| | | Amount |
|---|---|---|
| | | (Wt % |
| Component | Description | active) |
| 2-Pyrrolidone | Organic Cosolvent | 12 |
| Polycup ™ 7360A | Azetidinium-containing Polyamine | 4 |
| | Fixing Agent | |
| Surfynol ® 440 | Surfactant | 0.3 |
| Water | Solvent | Balance |
| Surface Tension | | 30-33 cP |

Polycup ™ is available from Solenis LLC (Delaware, USA).
Surfynol ® is available from Evonik, (Germany).

### Example 2 Preparation of Inkjet Ink Formulation

An inkjet ink formulation was made in accordance with the formulation that follows. The inkjet ink herein described is for a white pigment ink especially useful for printing on a dark textile.

TABLE 2
Inkjet Ink Formulation (White)

| | | Amount |
|---|---|---|
| | | (wt % |
| Component | Description | active) |
| White Pigment Dispersion | Pigment colorant | 10 |
| Impranil ® DLN-SD | Anionic aliphatic polyester- | 8 |
| | polyurethane dispersion binder | |
| Dowanol ® TPM | Tripopylene Glycol Methyl | 2 |
| | Ether cosolvent | |
| Liponic ® Ethoxylated | Humectant | 1 |
| Glycerol (LEG-1) | | |
| Surfynol ® 440 | Surfactant | 0.3 |
| Glycerol | Cosolvent | 9 |
| Acticide B20 | Biocide | 0.04 |
| Water | Solvent | Balance |

| | |
|---|---|
| pH | 8.5 |

Impranil ® is available from Covestro (Germany).
Dowanol ® TPM ™ is available from Dow Chemical (USA).
Surfynol ® is available from Evonik (Germany).
Acticide ® is available from Thor Specialties, Inc. (USA).
LEG-1 is available from Lipo Chemicals (USA)

### Example 3 Printing on Textile

The ink fixative formulation and white inkjet ink from Examples 1 and 2 respectively were both loaded into thermal inkjet pens (HP 11 ng drop weight pens) and the pens loaded onto an inkjet testbed. Four samples of dark cotton fabrics were subjected to the Method outlined in the present disclosure: Gildan® Midweight 780, Gildan® Lightweight 980, Gildan® Soft Style Ring Spun 64000.

The cotton fabrics were plasma pretreated using a Roplas RPS40 diffuse coplanar surface barrier discharge ambient air plasma system. The specifications of the unit are presented below

TABLE 3
Example plasma pretreatment system specifications

| Specification | Value |
|---|---|
| Power (W) | 40 |
| Plasma Area (cm²) | 7.5 |
| Plasma Volume (cm³) | 0.225 |
| Plasma Power Area Density (W/cm²) | 4.8 |
| Frequency(kHz) | 25 |
| Current (mA) | 2 |
| Voltage (kV) peak-to-peak | 15 |

The heat treatment steps of the method (104) and (110) were done using a 16″×20″ Hotronix Auto open clamshell hot press (Stahl's Hotronix, USA).

The textiles were treated with the Roplass RPS40 diffuse coplanar surface barrier discharge ambient air plasma system for 50 sec and then heat treated at 150° C. for 60 sec. Comparative samples were run without the post-plasma heat treatment. Following this the textiles were placed in the printing testbed where the ink fixative formulation and white inkjet ink were jetted one after another at 1.5 drops/pixel (9.2 grams per square meter (gsm)) for ink fixative formulation and 8 drops/pixel (49.1 gsm) for white inkjet ink for each pass, and this process was repeated 6 times to achieve a final ink fixative formulation and inkjet white ink loadings of 9 and 48 drops/pixel, respectively.

Following the print the textiles were dried in the clamshell hot press at 150° C. for 2 minutes.

Upon cooling the printed region was characterized using an XRite 939 spectrodensitometer (available from X-Rite, Michigan, USA) with a D50 illuminant at 2° measuring L* (higher L* values indicate a better white print). The results are summarized in the following table.

TABLE 4
Results

| | Plasma | | |
|---|---|---|---|
| Fabric | Pretreatment | Hot Press | L* |
| Gildan Black | n/a | n/a | 79 |
| MidWeight (780) | 30 sec | n/a | 82.5 |
| | n/a | n/a | 79.4 |
| | 50 sec | n/a | 82.7 |
| | n/a | 150° C./60 sec | 80.6 |
| | 50 sec | 150° C./60 sec | 90.3 |
| Gildan Black | n/a | 150° C./60 sec | 80.7 |
| Lightweight (980) | 50 sec | 150° C./60 sec | 89.4 |
| Gildan Black Soft Style | n/a | 150° C./60 sec | 83 |
| Ring Spun (64000) | 50 sec | 150° C./60 sec | 90.4 |

It can be seen that the plasma pretreatment increases the L* and results in a whiter print while combining plasma pretreatment with a hot press heat treatment significantly improves the white print.

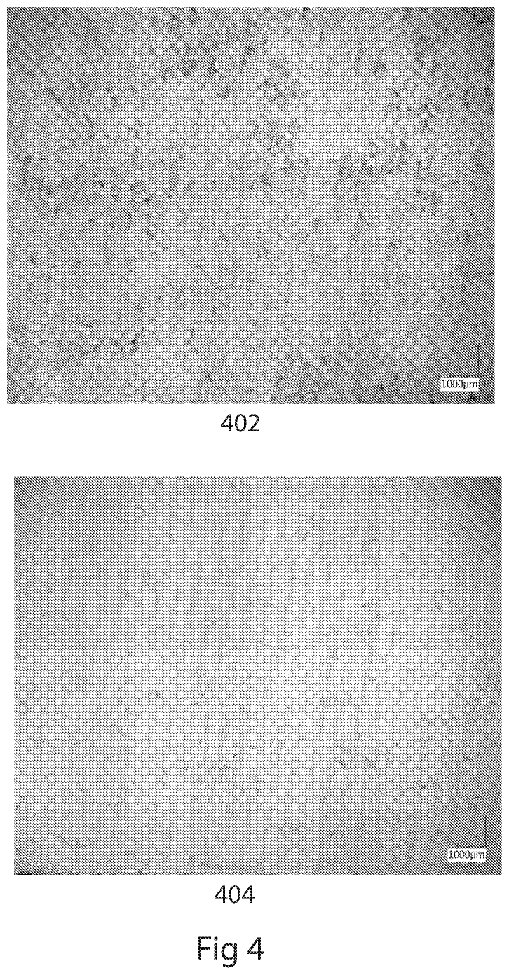

A better comparison can be shown by reference to FIG. 4 which shows two printed regions demonstrating a poor, low L* sample (402) and a good high L* print sample generated by the method of the present disclosure (404).

### Example 4 Washfastness

The textile substrates printed in Example 3 were then tested for washfastness by washing the prints 5 times in a Whirlpool Washer (Model WTW5000DW) (Whirlpool, USA) with warm water (at about 40° C.) and detergent. After 5 washes the L* values were measured using an X-Rite spectrodensitometer. The results are shown in the following table.

It can be seen that in those cases in which the plasma pretreatment was present the change in L* is less than when the plasma pretreatment is present.

TABLE 5
Results

| | Plasma | | ΔL* after 5 |
|---|---|---|---|
| Fabric | pretreatment | Hot Press | washes |
| Gildan Black | n/a | n/a | −2.8 |
| MidWeight (780) | 30 sec | n/a | −2.2 |
| | n/a | n/a | −3.3 |
| | 50 sec | n/a | −1.8 |
| | n/a | 150° C./60 sec | −3.1 |
| | 50 sec | 150° C./60 sec | −2.9 |
| Gildan Black | n/a | 150° C./60 sec | −3.1 |
| Lightweight (980) | 50 sec | 150° C./60 sec | −2.4 |
| Gildan Black Soft Style | n/a | 150° C./60 sec | −4.1 |
| Ring Spun (64000) | 50 sec | 150° C./60 sec | −2.9 |

It is to be understood that the ranges provided herein include the stated range and any value or sub-range within the stated range, as if the value(s) or sub-range(s) within the stated range were explicitly recited. For example, a range from about 5 wt % to about 25 wt %, should be interpreted to include not only the explicitly recited limits of from about 5 wt % to about 25 wt %, but also to include individual values, such as about 8 wt %, about 13.5 wt %, about 24 wt %, etc., and sub-ranges, such as from about 7 wt % to about 14.5 wt %, etc. Furthermore, when “about” is utilized to describe a value, this is meant to encompass minor variations (up to +/−10%) from the stated value.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

In describing and claiming the examples disclosed herein, the singular forms “a”, “an”, and “the” include plural referents unless the context clearly dictates otherwise.

While several examples have been described in detail, it is to be understood that the disclosed examples may be modified. Therefore, the foregoing description is to be considered non-limiting.

1. A method for printing of a textile comprising providing a textile substrate;
applying a plasma pretreatment;
applying a first heat treatment to the textile substrate;
applying an ink fixative agent;
applying an inkjet ink;
applying a second heat treatment.

2. The method of claim 1 in which the plasma pretreatment is applied using an ambient air plasma system.

3. The method of claim 2 in which the ambient air plasma system is a diffuse coplanar surface barrier discharge ambient air plasma system

4. The method of claim 1 in which the first heat treatment is applied at temperatures of 80° C. to 180° C. for a time of 15 sec to 5 min.

5. The method of claim 1 in which the ink fixative agent comprises:
a cationic fixing agent;
and water.

6. The method of claim 1 in which the ink fixative agent comprises:
an organic cosolvent;
a cationic fixing agent;
and water.

7. The method of claim 1 in which the ink fixative agent is applied by means of an inkjet printhead.

8. The method of claim 1 in which the inkjet ink is a white ink comprising:
a dispersion of a white pigment.

9. The method of claim 8 in which the white pigment is selected from a group consisting of titanium dioxide, zinc oxide, zirconium oxide, calcium carbonate, alumina, aluminum oxyhydroxide, kaolinite and combinations thereof.

10. The method of claim 1 in which the inkjet ink is applied to the substrate by means of an inkjet printhead.

11. The method of claim 1 in which the second heat treatment is applied at temperatures of 100° C. to 180° C. for a time of 30 sec to 20 min.

12. A printing system comprising:
a textile substrate;
a means of pretreating the textile substrate by means of plasma pretreatment using a plasma system;
a means of heating the plasma pretreated textile substrate after pretreatment;
a means of application of a pretreatment solution;
a means of printing of the textile substrate;
a pigment-based ink;
a means of providing a post-print drying of the plasma pretreated textile substrate which has been printed.

13. The printing system of claim 12 wherein the means of pretreating the textile substrate is an ambient air plasma system.

14. The printing system of claim 12 wherein the means of pretreating the textile substrate is a diffuse coplanar surface barrier discharge ambient air plasma system.

15. The printing system of claim 12 wherein the pigment-based ink is applied to the textile substrate by means of an inkjet printhead.
